(19) United States
(12) Patent Application Publication
(10) Pub. No.: US 2023/0325956 A1
(43) Pub. Date: Oct. 12, 2023

(54) METHOD, DEVICE AND SYSTEM FOR CALCULATING DANGER DEGREE OF EVENT SCENE

(71) Applicant: ELECTRONICS AND TELECOMMUNICATIONS RESEARCH INSTITUTE, Daejeon (KR)

(72) Inventors: Hyunho PARK, Daejeon (KR); Eunjung KWON, Daejeon (KR); Sungwon BYON, Daejeon (KR); Dong Man JANG, Daejeon (KR); Eui-Suk JUNG, Daejeon (KR)

(73) Assignee: ELECTRONICS AND TELECOMMUNICATIONS RESEARCH INSTITUTE, Daejeon (KR)

(21) Appl. No.: 18/164,405

(22) Filed: Feb. 3, 2023

(30) Foreign Application Priority Data
Mar. 23, 2022 (KR) 10-2022-0035781

(51) Int. Cl. G06Q 50/26

(52) U.S. Cl. CPC G06Q 50/265

(57) ABSTRACT

Disclosed herein a method, device and system for calculating danger degree of event scene. The method includes: calculating the danger degree of the event scene based on event scene information that includes report data of the event and at least one of brief situation data specifying an outline of an event and data about an event inducer; and providing response information for dealing with the event at the event scene based on the danger degree.

### CROSS REFERENCE TO RELATED APPLICATION

The present application claims priority to a Korean Patent Application 10-2022-0035781, filed Mar. 23, 2022, the entire contents of which are incorporated herein for all purposes by this reference.

### BACKGROUND OF THE INVENTION

### Field of the Invention

The present disclosure relates to a method, device and system for calculating a danger degree of an event scene and, more particularly, to a method, device and system for calculating a danger degree of an event scene, which not only support the response ability of an on-site officer at a public safety incident scene but also provide a suitable countermeasure for the incident scene.

### Description of the Related Art

Despite the fast advances of social security systems and related technologies, public security incidents in the modern society keep occurring even in various and unprecedented forms, and the number of life-threatening violent crimes tends to increase. Furthermore, the advancement of society aggravates the psychological anxiety of individual members and encourages acute conflicts of interest among members. Accordingly, violent crimes may not only be premeditated but also be those of opportunity ignited by petty arguments that intensify emotions. Crimes may have a variety of causes and do unexpected serious damage not only to victims but also to public security officers on the incident scenes. Accordingly, a public security officer needs to take an appropriate initial action at an incident scene and, when the incident develops into a violent crime, needs to increase the physical force level or to request the reinforcement of policing resources.

Currently, public security-related technologies are limited to preventing crimes, for example, by installing CCTV systems, and when a real incident occurs, a public safety agency, which have accepted a report, simply informs a dispatched officer of the situation of the incident scene as reported, and the officer arriving the scene responds to the situation based on his own judgment. For this reason, depending on the response ability of an officer at an incident scene, different initial actions are taken, and in case the situation is worsened, the scale of damage may be significantly different according to the response ability. Therefore, the action taken at an incident scene should not absolutely depend on the response ability of an officer at the scene, but a best solution needs to be implemented according to the situation of the scene, and a technology for such a reacting solution is demanded.

### SUMMARY

A technical object of the present disclosure is to provide a method, device and system for calculating a danger degree of an event scene, which not only support the response ability of an on-site officer at a public safety incident scene but also provide a suitable countermeasure for the incident scene.

The technical objects of the present disclosure are not limited to the above-mentioned technical objects, and other technical objects that are not mentioned will be clearly understood by those skilled in the art through the following descriptions.

According to the present disclosure, there is provided a method for calculating a danger degree of an event scene, which is implemented by a device comprising at least one processor, the method comprising: calculating the danger degree of the event scene based on event scene information that includes report data of the event and at least one of brief situation data specifying an outline of an event and data about an event inducer; and providing response information for dealing with the event at the event scene based on the danger degree.

According to the embodiment of the present disclosure in the method, the calculating of the danger degree may comprises calculating a victim danger degree for a victim and a responder danger degree for an event responder handling the event; and determining the danger degree of the event scene based on the victim danger degree and the responder danger degree.

According to the embodiment of the present disclosure in the method, the event scene information may further comprise briefing data of the event responder that handles the event and place data associated with the event scene.

According to the embodiment of the present disclosure in the method, the victim danger degree may be calculated according to a behavior type of the event inducer that is derived based on the event scene information, and the responder danger degree is calculated according to an action type of the event responder that is derived based on the event scene information, and the behavior type may be a type of resistance of the event inducer against the event responder, and the action type may be a control type according to an action that the event responder takes on the event inducer.

According to the embodiment of the present disclosure in the method, the victim danger degree and the responder danger degree may be calculated based on a parameter that comprises a type of the event, a sex and an age of the victim, the event inducer and the event responder, and a body damage degree of the victim and the event responder, which are estimated based on the event scene information, and the victim danger degree and the responder danger degree may be calculated by using a weighted value for each of the parameter.

According to the embodiment of the present disclosure in the method, the parameter may further comprise a responder defense degree that is estimated based on the event scene information, and the responder danger degree may be calculated by further comprising a weighted value for the responder defense degree.

According to the embodiment of the present disclosure in the method, a danger degree of an event subject may be calculated as a group danger degree that adds up a danger degree of each subject belonging to the group when the event subject belonging to at least one of the victim and the event responder is a group including a plurality of persons.

According to the embodiment of the present disclosure in the method, the calculating of the victim danger degree and the responder danger degree further may comprise calculating a third party danger degree for a third party who is present at the scene apart from the victim and the event responder.

According to the embodiment of the present disclosure in the method, the third party danger degree may be calculated according to a behavior type of the event inducer that is derived based on the event scene information, and the behavior type may be a type of resistance of the event inducer against the event responder.

According to the embodiment of the present disclosure in the method, the third party danger degree may be calculated based on a parameter that comprises the type of the event, a sex and an age of the third party, and neighborhood of the third party to the scene, which are estimated based on the event scene information, and the third party danger degree may be calculated by using a weighted value for each of the parameter.

According to the embodiment of the present disclosure in the method, a danger degree of an event subject may be calculated as a group danger degree that adds up a danger degree of each subject belonging to the group when the event subject, which belongs to at least one of the victim, the event responder and the third party, is a group including a plurality of persons.

According to the embodiment of the present disclosure in the method, the providing of the response information may comprise providing the response information based on the event inducer’s means of injury that is extracted from the event scene information, together with the danger degree.

According to another embodiment of the present disclosure, there is provided a device for calculating a danger degree of an event scene, comprising at least one processor, and the processor comprises a danger degree calculation unit and a response establishment unit. The danger degree calculation unit is configured to calculate the danger degree of the event scene based on event scene information that includes report data of the event and at least one of brief situation data specifying an outline of an event and data about an event inducer. The response establishment unit is configured to provide response information for dealing with the event at the event scene based on the danger degree.

According to another embodiment of the present disclosure, there is provided system for calculating a danger degree of an event scene, the system comprising: a user device configured to transmit report data of an event; and a device for calculating a danger degree of an event scene, which comprises at least one processor and provides information for dealing with the event based on the report data. The processor of the device for calculating a danger degree comprises a danger degree calculation unit and a response establishment unit. the danger degree calculation unit is configured to calculate the danger degree of the event scene based on event scene information that includes report data of the event and at least one of brief situation data specifying an outline of an event and data about an event inducer. The response establishment unit is configured to provide response information for dealing with the event at the event scene based on the danger degree.

The features briefly summarized above for this disclosure are only exemplary aspects of the detailed description of the disclosure which follow, and are not intended to limit the scope of the disclosure.

According to the present disclosure, a method, device and system for calculating a danger degree of an event scene may be provided which may not only support the response ability of an on-site officer at a public safety incident scene but also provide a suitable countermeasure for the incident scene.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view illustrating an example of a system for calculating a danger degree of an event scene with the purpose of describing the present disclosure.

FIG. 2 is a schematic block diagram of a device for calculating a danger degree of an event scene according to an embodiment of the present disclosure.

FIG. 3 is a block diagram for a danger degree calculation unit and a response establishment unit.

FIG. 4 is a flowchart of a method for calculating a danger degree of an event scene according to another embodiment of the present disclosure.

FIG. 5 is a view illustrating an example of brief situation data.

FIG. 6 is a view illustrating an example of calculating danger degrees of an event responder, a victim, and a third party.

FIG. 7 is a view exemplifying determination of a danger degree of an event scene.

FIG. 8 is a view illustrating another example of calculating danger degrees of an event responder, a victim, and a third party.

FIG. 9 is a view for describing parameters used to calculate a danger degree of FIG. 8.

FIG. 10 is a view explaining an example of calculating a danger degree of each group of event responders, victims, and third persons.

FIG. 11 is a view exemplifying response information according to a danger degree.

### DETAILED DESCRIPTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, ””at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, embodiments of the present disclosure will be described with reference to the accompanying drawings.

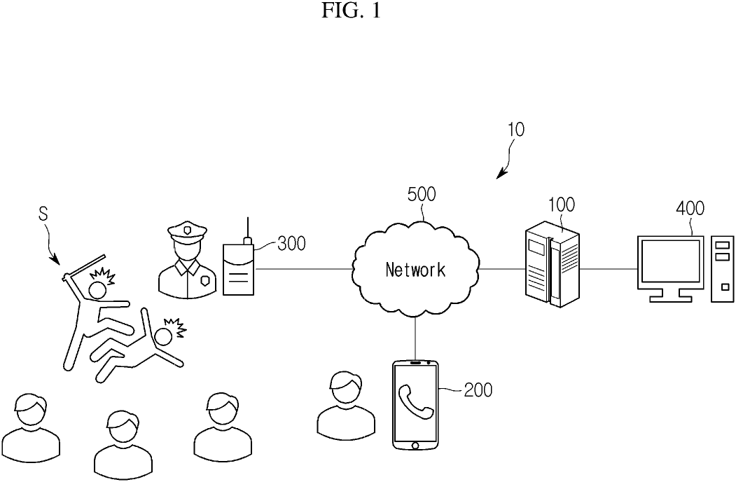

FIG. 1 is a view illustrating an example of a system for calculating a danger degree of an event scene with the purpose of describing the present disclosure.

A system 10 for calculating a danger degree of an event scene (hereinafter referred to as system) may be configured to include a device 100 for calculating a danger degree of an event scene (hereinafter referred to as danger degree calculating device), a user device 200 of a reporter (hereinafter referred to as reporter device), a device 300 of an event responder (hereinafter referred to as responder device), and a terminal 400 of an agency having an overall control over an event (hereinafter referred to as agency terminal). The danger degree calculating device 100 and the devices 200 to 400 may communicate in a wired or wireless way via a network 500.

Herein, an event may be an incident or an accident occurring at a scene, and incident scenes may be collectively called by the reference symbol S. For example, events may be various forms of accidents, in which there are arguments and assaults between people and the loss of life occurs or such arguments, assaults or the loss of life may occur, or incidents related to public security where the disturbance caused by a particular person does mental or physical damage to people around the person. Herein, for convenience of explanation, an event will be described as an example of public security-related incident. An event inducer and a victim are exemplified as a suspect (or assailant) of an incident and an incident victim, and these terms will be used interchangeably hereinafter. A reporter may be a person who informs an agency of the content of an incident at an incident scene S. An agency may be a policing or security agency that has an overall control in handling an incident of a scene S, which has been received by a report, and may forward incident-related information and a countermeasure to an event responder. Herein, the event responder may be an on-the-scene responder of a policing or security agency, which approaches the incident scene S and handles the incident on his own. Hereinafter, for convenience of explanation, an event responder will be used interchangeably with an on-the-scene responder, and the on-the-scene responder may be a police officer and a security guard, for example.

The danger degree calculating device 100 may be a type of a server that controls communication among the reporter device 200, the responder device 300, and the agency terminal 400. The danger degree calculating device 100 may analyze a reported incident and deliver a countermeasure for responding an incident of a scene S through the responder device 300. Hereinafter, the function and operation of the device 100 will be described.

The reporter device 200 may be a wired/wireless device that requests an incident report to the agency terminal 400 at the scene S. A reporter may be a victim of an incident or a third party near the scene S who is not related to the incident but may be subject to potential damage of the incident. The reporter device 200 may be equipped with a voice or face call module and have an application for exchanging information with the agency terminal 400 by using at least one of voice, video, and texts.

The responder device 300 may be configured as a communication device with a same type of function and modules as those of the reporter device 200 or may communicate with the agency terminal 400 in a unique way for security. The responder device 300 may be a device carried by an on-the-scene responder who approaches the scene S.

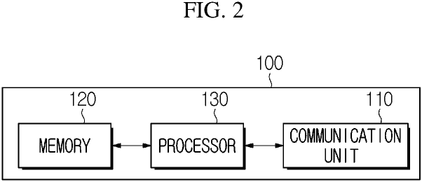

FIG. 2 is a schematic block diagram of a device for calculating a danger degree of an event scene according to an embodiment of the present disclosure.

The danger degree calculating device 100 may include a communication unit 110, a memory 120, and a processor 130.

The communication unit 110 may be equipped with a transmit/receive interface for exchanging signals with the reporter device 200 and the responder device 300 and establish communication with the devices 200 and 300 by accessing the agency terminal 400.

The memory 120 may store software or program for calculating a danger degree of an incident scene S and manage the software to be utilized at a request of the processor 130. In addition, the memory 120 may store information exchanged between the devices 200 and 300 and the agency terminal 400, for example, report data of the reporter device 200 and briefing data of the responder device 300. The memory 120 may store brief situation data, which specifies an outline of a reported incident and an initial action, and various types of data regarding past suspects and the incident scene and provide those data for calculating a danger degree. In addition, the memory 120 may manage systematic response action information including a response strategy and human resources according to a calculated danger degree.

The processor 130 may calculate a danger degree of an incident scene S by using the software and data stored in the memory 120, output response information, and establish a solution plan for the incident according to the response information.

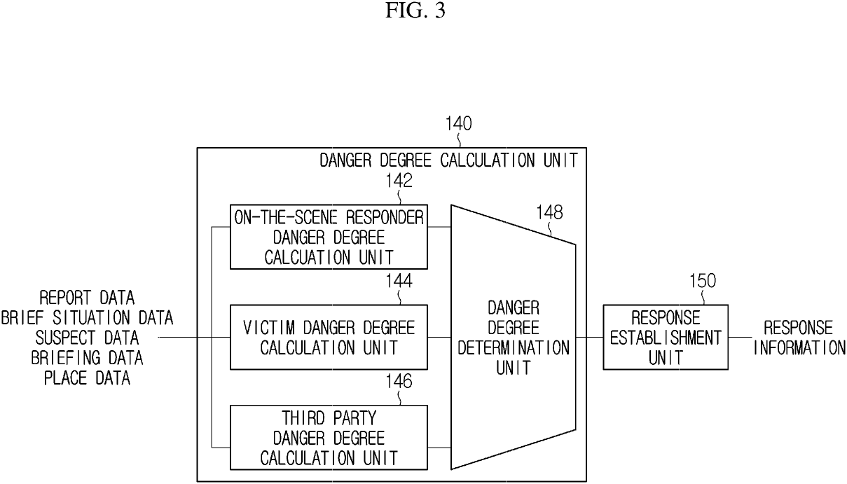

Specifically, the processor 130 may be configured to include, as shown in FIG. 3, a danger degree calculation unit 140 and a response establishment unit 150. FIG. 3 is a block diagram for a danger degree calculation unit and a response establishment unit.

The danger degree calculation unit 140 may calculate a danger degree of an incident scene S based on event scene information. According to the above-described example, the event scene information may be incident scene information. Incident scene information may include report data about a situation of an incident at a scene S through the reporter device 200. In addition, incident scene information may include at least one of brief situation data, event inducer data, briefing data, and place data. Data described below may be selectively included in incident scene information according to a characteristic of an incident and whether or not there is relevant data. The present disclosure is described with focus on an embodiment in which incident scene information includes not only report information but also all the data described below, but does not exclude an embodiment of calculating a danger degree based on at least one of the below-described data along with report data.

Brief situation data may include an outline of incident and an initial guideline, which are specified according to an incident situation of report data, and this will be described in detail below.

According to the above-described embodiment, event inducer data may be data of a suspect who is alleged to be an assailant in an incident. The processor 130 may estimate identification information of a suspect based on report data and briefing data and output suspect data based on the identification information. Suspect data may include information on dangerous behaviors done by the suspect and crime information.

Briefing data may be data that is transmitted, at a request of the agency terminal 400, from the responder device 300 of an on-the-scene responder who is dispatched or arrives at an incident scene S. For example, briefing data may be data about a scene situation, identification of a victim and a suspect, and initial and subsequent responses

Place data may be incident place data according to the above-described example. The processor 130 may generate incident place data based on location information that is identified based on report data and briefing data. For example, incident place data may be scene danger information that is generated based on detailed geographic information of the incident place, a facility, a dangerous object around the place, data of past incidents that occurred in the place.

Specifically, the danger degree calculation unit 140 may include an on-the-scene responder danger degree calculation unit 142, a victim danger degree calculation unit 144, a third party danger degree calculation unit 146, and a danger degree determination unit 148. In the present disclosure, the processor 130 may check whether or not there is a third party around the scene S except a victim and an on-the-scene responder, based on at least one of report data, briefing data, and incident place data. A third party may mean an unspecified person who is not affected by an incident or may be subject to potential damage. In case there is no third party, the processor 130 may not consider a third party’s danger degree according to the third party danger degree calculation unit 146 during a process of calculating a danger degree. The present disclosure is described with focus on an embodiment of calculating an overall danger degree that considers even a third party’s danger degree, but the description below may be practically applied to an embodiment of calculating a danger degree excluding a third party’s danger degree.

Based on a danger degree, the response establishment unit 150 may provide response information for coping with an incident at the scene S to at least one of the agency terminal 400 and the responder device 300.

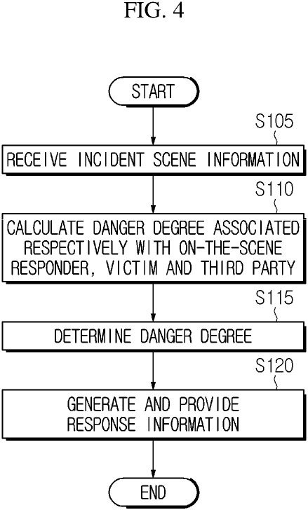

Detailed operations of the danger degree calculation unit 140 and the response establishment unit 150 will be described in detail below with reference to various embodiments according to a method of calculating a danger degree of an event scene in FIG. 4 to FIG. 11.

FIG. 4 is a flowchart of a method for calculating a danger degree of an event scene according to another embodiment of the present disclosure.

The danger degree calculating device may receive report data from the reporter device 200, and the danger degree calculation unit 140 may receive incident scene information including brief situation data, suspect data, incident place data and briefing data according to the report data (S105).The briefing data may be data about an actual scene, which is transmitted from the responder device 300 after arriving at the scene S, and including information on an initial action plan of an on-the-scene responder that is transmitted from the responder device 300 before arriving at the scene S.

By referring to overall brief situation data managed in the memory 120, the danger degree calculation unit 140 may extract an outline of an incident and an initial guideline according to an incident situation of briefing data and receive brief situation data suitable for a reported incident. For example, the outline of an incident may be determined according to an urgency degree of a reported incident, and an initial guideline may include a dispatch guideline corresponding to the urgency degree.

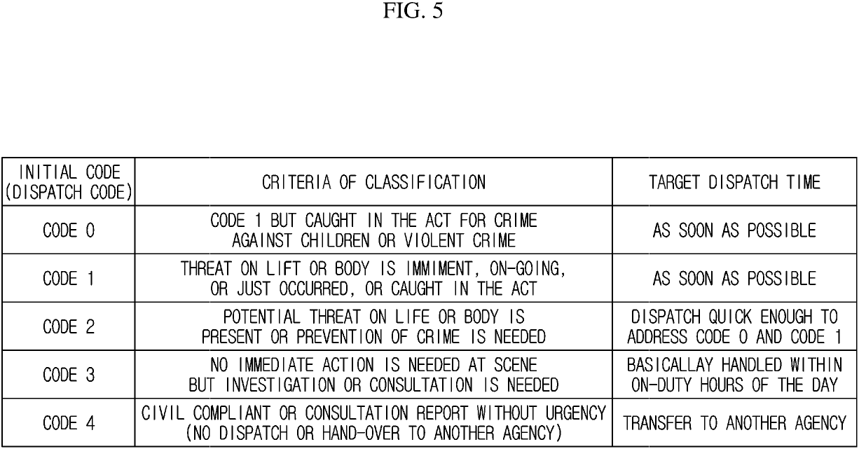

FIG. 5 is a view illustrating an example of brief situation data.

The outline of an incident may be a brief scene situation and an urgency degree according to a classification criterion based on report data and designated codes of classification criteria specified by the agency terminal 400 as exemplified in FIG. 5. As another example, when the processor 130 selects and matches a scene situation and an urgency degree corresponding to report data among data of classification criteria exemplified in FIG. 5, brief situation data may be determined. For example, an initial guideline in brief determination data may employ a target dispatch time corresponding to an initial code (e.g., dispatch code) of a classification criterion as a dispatch guideline. The agency terminal 400 or the danger degree calculating device 100 may transmit brief situation data to the responder device 300 that is allocated a scene S.

Next, the danger degree calculation unit 140 may calculate a danger degree of an on-the-scene responder, a danger degree of a victim, and a danger degree of a third party respectively based on incident scene information (S110).

Specifically, the on-the-scene responder danger degree calculation unit 142 may calculate a danger degree of a responder who is dispatched to a scene S in order to handle an incident. A danger degree of a victim and a danger degree of a third party may be calculated by the victim danger degree calculation unit 144 and the third party danger degree calculation unit 146 respectively.

FIG. 6 is a view illustrating an example of calculating danger degrees of an event responder, a victim, and a third party.

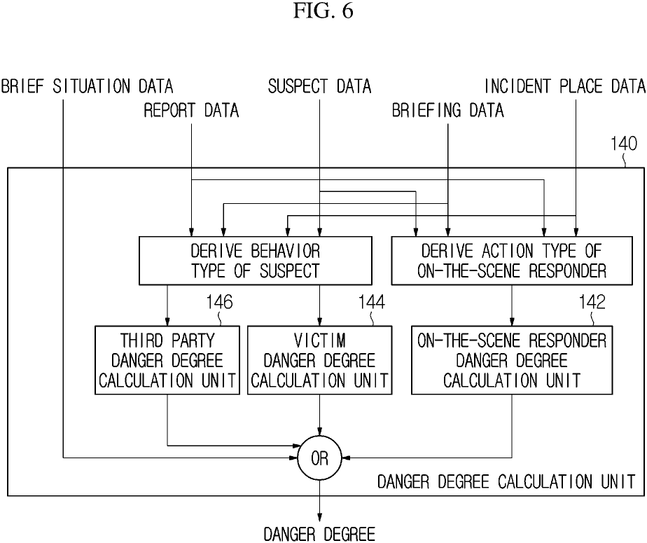

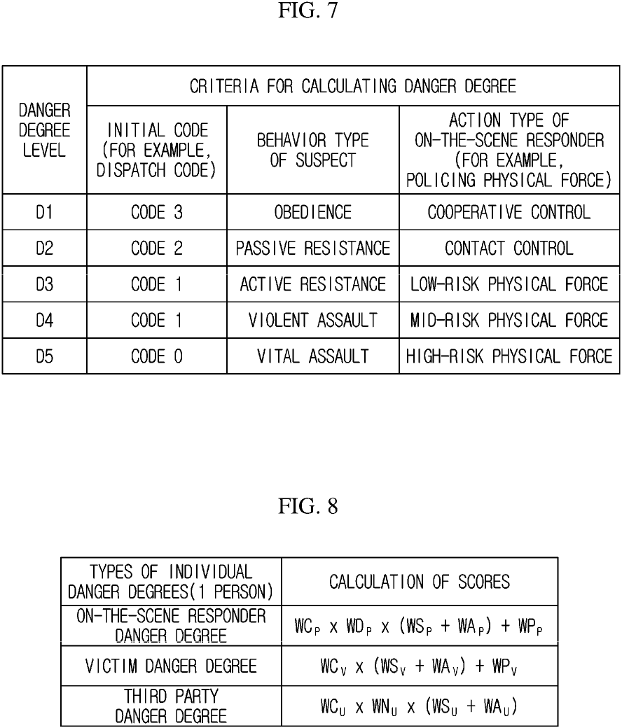

Referring to FIG. 6, the danger degree calculation unit 140 may derive a behavior type of a suspect based on incident scene information excluding, for example, brief situation data, and the victim danger degree calculation unit 144 may calculate a danger degree of a victim based on the behavior type. For example, the behavior type may be a resistance type of a suspect against an on-the-scene responder. A behavior type may be exemplified by the behavior type of FIG. 7. The behavior type exemplified in FIG. 7 may be divided into five stages of obedience, passive resistance, active resistance, violent assault, and vital assault according to criteria for judging a suspect’s behavior, and the suspect’s behavior may be determined according to each stage.

For example, the third party danger degree calculation unit 146 may also calculate a danger degree of a third party based on a behavior type of a suspect.

As an example, the danger degree calculation unit 140 may derive an action type of an on-the-scene responder based on incident scene information excluding brief situation data, and the on-the-scene responder danger degree calculation unit 142 may calculate a danger degree of the on-the-scene responder based on a control type. For example, an action type may be a rough control type according to an action that the on-the-scene responder takes on a suspect. Specifically, an action type may be a level of physical force that an on-the-scene responder such as a police officer is going to use or is using on a suspect. As exemplified in FIG. 7, an action type may be divided into five stages of cooperative control, contact control, low-risk physical force, mid-risk physical force, and high-risk physical force according to the use criteria of physical force.

Next, the danger degree determination unit 148 may determine a danger degree of an incident scene S based on a danger degree of each subject (S115).

If FIG. 7 is described as an example, a danger degree of a scene S may be determined based on brief situation data and danger degrees of each subject that are calculated based on a behavior type of a suspect and an action type of an on-the-scene responder. FIG. 7 is a view exemplifying determination of a danger degree of an event scene.

As exemplified in FIG. 7, a danger degree level may be determined according to an initial code (configuration information of brief situation data), a behavior type of a suspect, and a physical force (an example of action). Criteria for calculating a danger degree may be connected by “OR” condition as in FIG. 6. For example, a danger degree D1 may be given when at least one of an initial code “code 3”, a suspect’s behavior type “obedience”, and a policing physical force “cooperative control” is output. A danger degree D5 may be given when at least one of an initial code “code 0”, a behavior type “vital assault”, and a policing physical force “high-risk physical force” is output. That is, even when an initial code and an action type are output at a relatively low level, if a suspect’s behavior type is at a high level, an incident scene S may be determined to have a high danger degree. Accordingly, the danger degree of a scene S may be estimated by considering an overall situation of the scene S.

According to an example, steps S110 and S115 show an embodiment of calculating a danger degree based on a behavior type of a suspect according to incident scene information, an action type of an on-the-scene responder, and brief situation data.

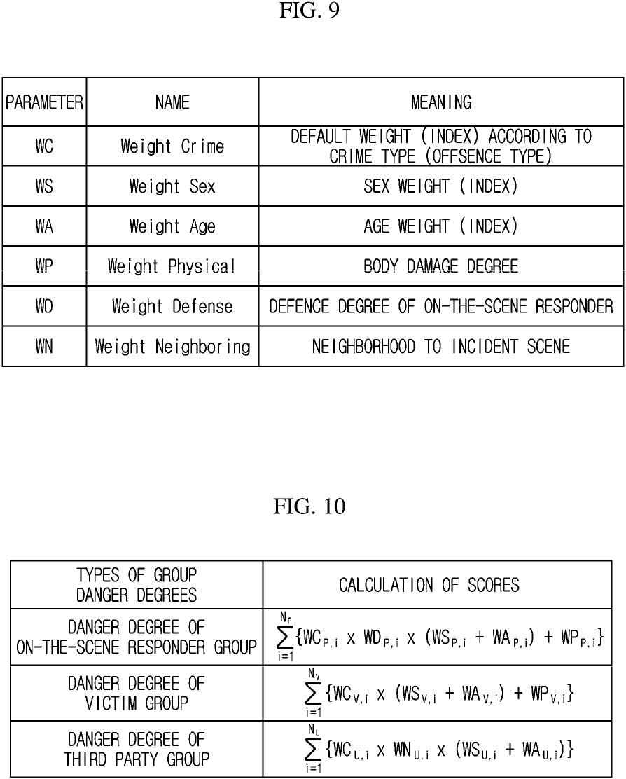

As another example, steps S110 and S115 may calculate a danger degree of each subject by using a plurality of parameters estimated from incident scene information and also calculate a danger degree of an incident scene S according to the calculated danger degree. Referring FIG. 8 and FIG. 9, an embodiment associated with another example will be described. FIG. 8 is a view illustrating another example of calculating danger degrees of an event responder, a victim, and a third party. FIG. 9 is a view for describing parameters used to calculate a danger degree of FIG. 8.

At step S110, the victim danger degree calculation unit 144, the on-the-scene responder danger degree calculation unit 142, and the third party danger degree calculation unit 146 may calculate corresponding danger degrees by using a plurality of parameters that are estimated from incident scene information. For example, danger degrees for respective subjects may be calculated as scores through mathematical formulas exemplified in FIG. 8, and each mathematical formula may be a formula that is configured based on a single person.

The parameters used for the mathematical formulas of FIG. 8 are described in FIG. 9, and the subscripts V, P and U of the parameters indicate a victim, an on-the-scene responder, and a third party respectively. Accordingly, each the parameters of FIG. 9 may have a different value according to a subject of calculating a danger degree. Specifically, even when there is a same incident type of an incident scene S, different parameter values may be estimated according to the perspective of a subject. Accordingly, as each danger degree is calculated by being tailored to each subject even in a same incident scene S, danger degrees thus determined may reflect an incident situation more accurately.

As detailed description of each parameter and a danger degree for each subject with reference to FIG. 8 and FIG. 9, the parameter WC may be an index or a weighted value associated with an incident type that the processor 130 estimates from at least one of a plurality of datasets of incident scene information. The parameter WS may be an index or a weighted value associated with the sex of a victim, a suspect, and an on-the-scene responder, which is estimated from at least one of the plurality of datasets. The parameter WA may be an index or a weighted value associated with the age of a victim, a suspect, and an on-the-scene responder, which is estimated from at least one of the plurality of datasets. The parameter WP may be a value associated with body damage of a victim, which is estimated from at least one of the plurality of datasets. The parameter WD may be a value associated with defense degree of an on-the-scene responder, which is estimated from at least one of the plurality of datasets. The parameter WN may be a value associated with a third party’s neighborhood to an incident scene S, which is estimated from at least one of the plurality of datasets.

Based on this, the danger degree of an on-the-scene responder exemplified in FIG. 8 may be calculated based on weighted values for an incident type WCp, a defense degree WDp of the on-the-scene responder, the sex WSp and age WAp of the on-the-scene responder, and body damage WPp of the on-the-scene responder. Sex (WSp), age (WAp) and body damage (WPp) may be adjusted by considering the same kinds of parameter values of a victim and a third party.

The danger degree of a victim may be calculated based on weighted values for an incident type WCv, the sex WSv and age WAv of the victim, and body damage WPv of the victim.

The danger degree of a third party may be calculated based on weighted values for an incident type WCu, the sex WSu and age WAu of the third party, and neighborhood WNu of the third party to an incident scene S.

At step S115, the danger degree determination unit 148 may calculate a danger degree of an incident scene S based on a danger degree of each subject. For example, the danger degree determination unit 148 may calculate a danger degree by adding up danger degrees of subjects but, as another example, calculate a danger degree by applying a weight for each danger degree. Not limited to the above-described example, the danger degree determination unit 148 may calculate a danger degree in various ways based on a danger degree of each subject.

Steps S110 and S115 according to the above-described example show an embodiment of calculating a danger degree by assuming that each subject is a single person.

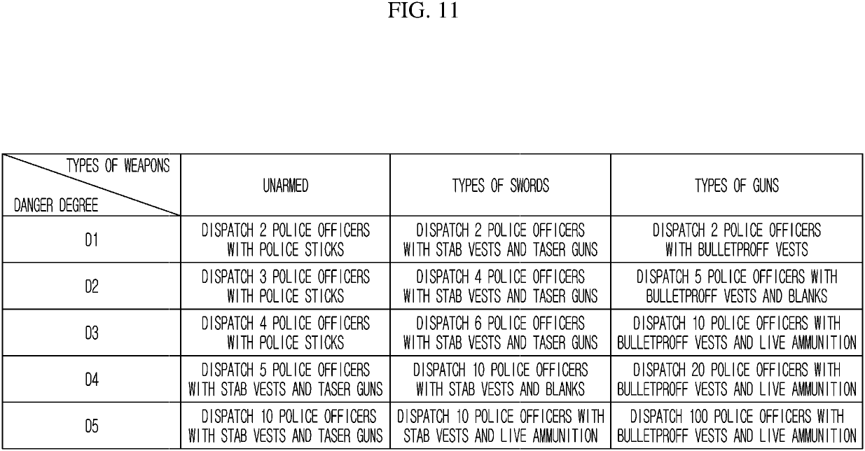

As another example, when it is determined, based on incident scene information, that there is a plurality of subjects in at least one subject group, steps S110 and S115 may determine a danger degree of an incident scene S by adding up danger degrees of groups to which each subject belongs. Referring to FIG. 10, an embodiment associated with another example will be described. FIG. 10 is a view explaining an example of calculating a danger degree of each group of event responders, victims, and third persons. Hereinafter, for convenience of explanation, calculation of a danger degree will be described under the assumption that there are a plurality of victims, a plurality of on-the-scene responders and a plurality of third persons, but in case only a part of those subject groups has a plurality of members, the embodiment described below is applicable to the corresponding group.

At step S110, since the victim group, the on-the-scene responder group, and the third party group are groups including a plurality of members, the victim danger degree calculation unit 142 may calculate a danger degree of the victim group, and the on-the-scene responder danger degree calculation unit 144 may calculate a danger degree of the on-the-scene responder group. In addition, the third party danger degree calculation unit 146 may calculate a danger degree of the third party group.

Danger degrees of each group may be calculated by using the mathematical formulas exemplified in FIG. 10. The formulas exemplified in FIG. 10 are extensions of the formulas of FIG. 8 according to the number of persons. In FIG. 10, Nₚ, Nᵥ, and Nᵤ may be the number of on-the-scene responders, the number of victims, and the number of the third persons for calculating a danger degree of each group. As another example, a danger degree of each group may be calculated by using the calculation process of FIG. 6.

At step S115, the danger degree determination unit 148 may calculate a danger degree of an incident scene S based on a danger degree of each group. For example, the danger degree determination unit 148 may calculate a danger degree by adding up danger degrees of each group but, as another example, calculate a danger degree of a scene S by applying a weight for each danger degree. Not limited to the above-described example, the danger degree determination unit 148 may calculate a danger degree in various ways based on a danger degree of each group.

Referring to FIG. 4 again, the response establishment unit 150 may generate and provide response information for handling an event based on a danger degree output from the danger degree determination unit 148.

Response information may be provided to an on-the-scene responder who has already been on a scene. As another example, the response establishment unit 150 may generate follow-up response information based on briefing data of an on-the-scene responder who is on a scene. In this case, response information may be generated to enforce or increase the number of on-the-scene responders, physical force, weapons carried by the responders, and the like.

FIG. 11 is a view exemplifying response information according to a danger degree. As exemplified in FIG. 11, the response establishment unit 150 may provide response information based on, together with a danger degree, a suspect’s means of injury extracted from incident scene information, for example, a weapon carried by the suspect.

According to the present disclosure, it is possible not only to support the response ability of an on-the-scene responder at a public safety incident scene but also to provide a suitable countermeasure for the incident scene without relying on the response ability of the on-the-scene responder.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for calculating a danger degree of an event scene, which is implemented by a device comprising at least one processor, the method comprising:
calculating the danger degree of the event scene based on event scene information that includes report data of the event and at least one of brief situation data specifying an outline of an event and data about an event inducer; and
providing response information for dealing with the event at the event scene based on the danger degree.

2. The method of claim 1, wherein the calculating of the danger degree comprises:
calculating a victim danger degree for a victim and a responder danger degree for an event responder handling the event; and
determining the danger degree of the event scene based on the victim danger degree and the responder danger degree.

3. The method of claim 2, wherein the event scene information further comprises briefing data of the event responder that handles the event and place data associated with the event scene.

4. The method of claim 3, wherein the victim danger degree is calculated according to a behavior type of the event inducer that is derived based on the event scene information, and the responder danger degree is calculated according to an action type of the event responder that is derived based on the event scene information, and
wherein the behavior type is a type of resistance of the event inducer against the event responder, and the action type is a control type according to an action that the event responder takes on the event inducer.

5. The method of claim 3, wherein the victim danger degree and the responder danger degree are calculated based on a parameter that comprises a type of the event, a sex and an age of the victim, the event inducer and the event responder, and a body damage degree of the victim and the event responder, which are estimated based on the event scene information, and
wherein the victim danger degree and the responder danger degree are calculated by using a weighted value for each of the parameter.

6. The method of claim 5, wherein the parameter further comprises a responder defense degree that is estimated based on the event scene information, and
wherein the responder danger degree is calculated by further comprising a weighted value for the responder defense degree.

7. The method of claim 2, wherein a danger degree of an event subject is calculated as a group danger degree that adds up a danger degree of each subject belonging to the group when the event subject belonging to at least one of the victim and the event responder is a group including a plurality of persons.

8. The method of claim 2, wherein the calculating of the victim danger degree and the responder danger degree further comprises calculating a third party danger degree for a third party who is present at the scene apart from the victim and the event responder.

9. The method of claim 8, wherein the third party danger degree is calculated according to a behavior type of the event inducer that is derived based on the event scene information, and the behavior type is a type of resistance of the event inducer against the event responder.

10. The method of claim 8, wherein the third party danger degree is calculated based on a parameter that comprises the type of the event, a sex and an age of the third party, and neighborhood of the third party to the scene, which are estimated based on the event scene information, and
wherein the third party danger degree is calculated by using a weighted value for each of the parameter.

11. The method of claim 8, wherein a danger degree of an event subject is calculated as a group danger degree that adds up a danger degree of each subject belonging to the group when the event subject, which belongs to at least one of the victim, the event responder and the third party, is a group including a plurality of persons.

12. The method of claim 1, wherein the providing of the response information comprises providing the response information based on the event inducer’s means of injury that is extracted from the event scene information, together with the danger degree.

13. A device for calculating a danger degree of an event scene, comprising at least one processor,
wherein the processor comprises a danger degree calculation unit and a response establishment unit,
wherein the danger degree calculation unit is configured to calculate the danger degree of the event scene based on event scene information that includes report data of the event and at least one of brief situation data specifying an outline of an event and data about an event inducer, and
wherein the response establishment unit is configured to provide response information for dealing with the event at the event scene based on the danger degree.

14. The device of claim 13, wherein the danger degree calculation unit comprises:
a victim danger degree calculation unit configured to calculate a victim danger degree for a victim;
a responder danger degree calculation unit configured to calculate a responder danger degree for an event responder handling the event; and
a danger degree determination unit configured to determine the danger degree of the event scene based on the victim danger degree and the responder danger degree.

15. The device of claim 14, wherein the event scene information further comprises briefing data of the event responder who handles the event and place data associated with the event scene.

16. The device of claim 15, wherein the victim danger degree is calculated according to a behavior type of the event inducer that is derived based on the event scene information, and the responder danger degree is calculated according to an action type of the event responder that is derived based on the event scene information, and
wherein the behavior type is a type of resistance of the event inducer against the event responder, and the action type is a control type according to an action that the event responder takes on the event inducer.

17. The device of claim 15, wherein the danger degree calculation unit is configured to estimate, based on the event scene information, a parameter that comprises a type of the event, a sex and an age of the victim, the event inducer and the event responder, and a body damage degree of the victim and the event responder, and
wherein the victim danger degree and the responder danger degree are calculated by using a weighted value for each of the parameter.

18. The device of claim 17, wherein the parameter further comprises a responder defense degree that is estimated based on the event scene information, and
wherein the responder danger degree is calculated by further comprising a weighted value for the responder defense degree.

19. The device of claim 14, wherein the danger degree calculation unit further comprises a third party danger degree calculation unit configured to calculate a third party danger degree for a third party who is present at the scene apart from the victim and the event responder.

20. A system for calculating a danger degree of an event scene, the system comprising:
a user device configured to transmit report data of an event; and
a device for calculating a danger degree of an event scene, which comprises at least one processor and provides information for dealing with the event based on the report data,
wherein the processor of the device for calculating a danger degree comprises a danger degree calculation unit and a response establishment unit,
wherein the danger degree calculation unit is configured to calculate the danger degree of the event scene based on event scene information that includes report data of the event and at least one of brief situation data specifying an outline of an event and data about an event inducer, and
wherein the response establishment unit is configured to provide response information for dealing with the event at the event scene based on the danger degree.
